(19) United States
(12) Patent Application Publication
(10) Pub. No.: US 2013/0294680 A1
(43) Pub. Date: Nov. 7, 2013

(54) IMAGE CLASSIFICATION METHOD AND IMAGE CLASSIFICATION APPARATUS

(71) Applicants: Minoru Harada, Fujisawa (JP); Ryo Nakagaki, Kawasaki (JP); Takehiro Hirai, Ushiku (JP)

(72) Inventors: Minoru Harada, Fujisawa (JP); Ryo Nakagaki, Kawasaki (JP); Takehiro Hirai, Ushiku (JP)

(73) Assignee: HITACHI HIGH-TECHNOLOGIES CORPORATION, Tokyo (JP)

(21) Appl. No.: 13/979,450

(22) PCT Filed: Dec. 7, 2011
(86) PCT No.: PCT/JP2011/006837

§ 371 Date: Jul. 12, 2013

(30) Foreign Application Priority Data
Jan. 19, 2011 (JP) 2011-008387

(51) Int. Cl. G06T 7/00

(52) U.S. Cl. CPC G06T 7/0004
USPC 382/149

(57) ABSTRACT

In an apparatus for automatically classifying an image picked up of a defect on a semiconductor wafer according to user defined class, when images picked up by a plurality of different observation apparatuses are inputted in a mixed manner, the defect image classification accuracy rate decreases due to image property differences corresponding to differences in the observation apparatuses. In an automatic image classification apparatus supplied with defect images picked up by a plurality of observation apparatuses, when preparing a recipe, image process parameters are adjusted and a classification discriminating surface is prepared for each observation apparatus. When classifying an image, the observation apparatus that picked up a defect image is identified based on accompanying information or the like of the image, and an image process and a classification process are performed by using the image process parameters and the classification discriminating surface corresponding to the observation apparatus that picked up the image. In order to efficiently adjust the image process parameters for each observation apparatus, appropriate image process parameters are automatically adjusted on the basis of an exemplified defect area. The image process parameters adjusted in a given observation apparatus may be used for setting the image process parameters for another observation apparatus.

### TECHNICAL FIELD

The present invention relates to a classification of images, and more particularly to a method and an apparatus for classifying defect images produced by picking up pattern defects or attached foreign substances generated during manufacture of semiconductor devices.

### BACKGROUND

In the manufacturing processes of semiconductor wafers, it sometimes happens that foreign substances generated from various manufacturing apparatuses may cause short-circuiting in the finished circuit patterns, or that the quality of finished circuit patterns may be poor due to an erroneous setting of the operating conditions for manufacturing processes. Those semiconductor chips which contain such defects are deemed unusable, and therefore lower the yields of semiconductor products. Accordingly, in order to improve the product yields, it is necessary to early determine the cause of defects occurring and to take appropriate measures.

A defect inspection apparatus and a defect observation apparatus are used in a semiconductor wafer manufacturing line to determine the causes of defects being incurred. The defect inspection apparatus is an apparatus which picks up images by utilizing an optical means or a pickup means using charged particle beams, analyzes the obtained images, determines the positions of defects, and delivers the processed result. Since such a defect inspection apparatus must usually scan a wide area at a high velocity, the resolution of picked-up defects tends to be low and therefore it is difficult to determine the cause of defects being incurred through the detailed inspection of the generated defects. In order to overcome this weak point, the defect observation apparatus comes to be used which picks up, with a high resolution, a defect at the coordinate point that the defect inspection apparatus delivered. In recent years, with increasing demands for even further miniaturization of semiconductor printed circuit patterns, the smallest size of a defect to be observed has been lowered down to the order of several tens of nm, and therefore defect observation apparatuses have been in wide use which employ SEMs (scanning electron microscopes) with resolutions in the order of several nm.

For the purpose of determining the causes of defects and feeding the determined result to the manufacturing process, the defect inspection and the defect observation are performed in the respective stages of the manufacturing process so that the types of defects are determined during the occurrence thereof. For example, a defect observation apparatus picks up the images of defects with respect to the several tens of defect points randomly sampled from the several hundreds of defect coordinate points delivered by a defect inspection apparatus, so that the classification of the defects takes place.

As the semiconductor printed circuit patterns have been miniaturized even further in recent years, however, defect inspection apparatuses came to increasingly deliver erroneous outputs. It sometimes happens that in the case where several tens of observation points are randomly sampled from several thousands of image points of defects delivered from a defect inspection apparatus, defects that might cause fatal results cannot be observed. Further, with the diversification of semiconductor manufacturing processes, types of generated defects have increased in number. It therefore is important to collect as many defect images as possible (e.g. several hundreds of images) and to assess the occurring frequency of respective types of defects. For this purpose, automatic defect classifications (ADCs) are now underway wherein about several hundreds of defect images obtained are classified according to their cause of occurrence or their features of appearances.

The Patent Literature 1 given below discloses one of the ADC procedures wherein the appearance feature of any defective portion is quantified through image processing and the quantified result is classified by using a neural network. Further, the Patent Literature 2 given below discloses a classification method using a rule-based classification method and an example-based classification method in combination, which can be easily adapted to a case where there are many types of defects to be classified.

Historically, defect images were classified manually by an observation apparatus and the observation apparatus was usually provided with, as one of its functions, the function of automatically classifying defect images. With an increase in the amount in manufacturing of semiconductor products, however, a plurality of observation apparatuses came to be provided for a semiconductor wafer manufacturing line. As a result, a problem arose from an increase in the cost of managing classification recipes. The Patent Literature 3 given below, which aims to solve this problem, discloses a method wherein defect image classification is performed by connecting a plurality of observation apparatus with an automatic image classification apparatus in a network and then by transferring the obtained images to the automatic image classification apparatus. With this method, the management of defect images and classification recipes can be centralized and therefore the management cost can be reduced. Moreover, the Patent Literature 4 given below discloses a method, as one of methods for exemplifying defect classes necessary for composing classification recipes, for easily and effectively exemplifying defect classes by moving iconized defect images to window areas allocated to respective defect classes.

### CITATION LIST

### Patent Literature

PATENT LITERATURE 1: JP-A-8-021803
PATENT LITERATURE 2: JP-A-2007-225531
PATENT LITERATURE 3: JP-A-2004-226328
PATENT LITERATURE 4: JP-A-2000-162135

### SUMMARY OF INVENTION

### Technical Problem

As described above, in order to manufacture semiconductor wafers at high yields, it is important to grasp the occurring frequency of defects generated in the manufacturing process with respect to their types, to determine the causes of fatal defects being generated, and to feed the determined result back to the manufacturing process early. It should be noted here that the exact grasp of the occurring frequency of defects with respect to their types requires automatically classifying about several hundreds of defect images picked up by the observation apparatus. Further, regarding automatic classification, since the cost of managing images and classification recipes should be reduced, one or more automatic image classification apparatuses, whose number is smaller than the number of the observation apparatuses employed, must be able to perform automatic image classification. In this case, since defect images which are picked up by various image pickup apparatuses and hence have different properties, are inputted to the automatic image classification apparatuses in a mixed way, correct image classification by conventional automatic image classification apparatuses, which are supposed to receive defect images of the same property, cannot be performed at highly successful rates. This comes from two problems. One problem is that since in the process of extracting defect areas by an automatic image classification apparatus, different observation apparatuses generate images of different quality, then the processes with the same set of parameters will cause different results in image extraction. One example of this situation is shown in FIG. 1, which shows different results that were obtained when two observation apparatuses (referred to as observation apparatuses A and B) picked up images of the same defect and then defect area extraction processes under the same set of parameters were performed. Let it be assumed that the defect area extraction process performed on a defect image 101 picked up by the observation apparatus A could extract a correct defect area such as shown at reference numeral 102. Then, the defect area extraction process performed on a defect image 103 picked up by the observation apparatus B under the same set of parameters may extract an erroneous defect area such as shown at reference numeral 104 due to the difference in image quality. The other problem is as follows. The automatic image classification apparatus in general quantifies the features (e.g. brightness, shape, etc.) of a defect image and uses the features as criteria for classification. It may happen that different image pickup apparatuses produce different quantification results even when they process the same defect image, since they recognize the same defect in different ways. FIG. 2 schematically shows the distribution map plotted in the n-dimensional feature-quantity space 201, constructed on the basis of two types of defects (e.g. short-circuiting and contamination by foreign substances) picked up by the observation apparatuses A and B. Since different observation apparatuses result in defect images of different qualities for the same defect, then it may happen that although the short-circuiting defects result in the same distribution 202 irrespective of the observation apparatuses A and B, the defects generated by foreign substances cause the distribution to be split into one part 203 for the observation apparatus A and the other part 204 for the observation apparatus B. This outcome indicates that the degree of separation of distributions in the feature-quantity space, as compared with picking up by a single observation apparatus, becomes poorer and therefore the classification performance becomes poorer, too.

It is therefore required that even when the automatic image classification apparatus received as its inputs images picked up by different observation apparatuses in a mixed way, it should be able to absorb the differences in quality of images picked up by the different observation apparatuses and to correctly classify the images according to their types.

### Solution to Problem

In order to solve the above problem, in an automatic image classification apparatus which receives as its input defect images picked up by a plurality of observation apparatuses, an observation apparatus that picked up a defect image is identified on the basis of the accompanying information of the image; when a classification recipe is generated, image processing parameters are adjusted and classification discriminating surfaces are generated with respect to respective observation apparatuses; and when images are classified, image processing and classification processing are both performed by using those image processing parameters and classification discriminating surface corresponding to the observation apparatus that picked up the image of interest. Further, to effectively adjust the image processing parameters for each observation apparatus, appropriate image processing parameters are obtained through automatic adjustment based on exemplified defect area. Furthermore, on the basis of image processing parameters adjusted for an observation apparatus, image processing parameters for another observation apparatus are determined.

Typical inventions disclosed in this specification will be briefly described below.

(1) An image classification method for classifying a plurality of defect images picked up by a plurality of different image pickup apparatuses according to types of defects, comprising the steps of: reading accompanying information of a defect image to be classified; identifying, from the plurality of the different image pickup apparatuses, the image pickup apparatus which picked up the defect image to be classified, on the basis of the read accompanying information of the defect image to be classified; reading the set of classification parameters for the identified image pickup apparatus from a plurality of classification parameter sets previously compiled for the plurality of the different image pickup apparatuses; and classifying the defect image to be classified by using the read set of classification parameters.
(2) An image classification apparatus that classifies a plurality of defect images picked up by a plurality of different image pickup apparatuses according to types of defects, comprising a storage unit that stores the defect images, pieces of accompanying information corresponding respectively to the defect images, and sets of classification parameters which correspond respectively to the plurality of different image pickup apparatuses; a classification parameter selection unit that selects and identifies the image pickup apparatus which picked up the defect image to be classified, from among the plurality of different image pickup apparatuses on the basis of the piece of accompanying information corresponding to the very defect image to be classified, read from the storage unit and that selectively writes therein the set of classification parameters corresponding to the identified image pickup apparatus; a classification processing unit that classifies the defect image to be classified, on the basis of the set of parameters selected by and written in, the classification parameter selection unit; and a display unit that displays the classification results obtained by the classification processing unit.

### Advantageous Effects of Invention

According to this invention, there is provided an image classification apparatus and an image classification method according to which an image classification apparatus for classifying defect images picked up by a plurality of observation apparatuses can absorb the differences in quality of the defect images resulting from their being picked up by different observation apparatuses, and classify the defect images without deteriorating the classification performance despite the differences.

### BRIEF DESCRIPTION OF DRAWINGS

FIG. 1 shows the defect images obtained when two different observation apparatuses picked up images of the same defect and the defect area extracted in a defect area extraction process under the same set of parameters;

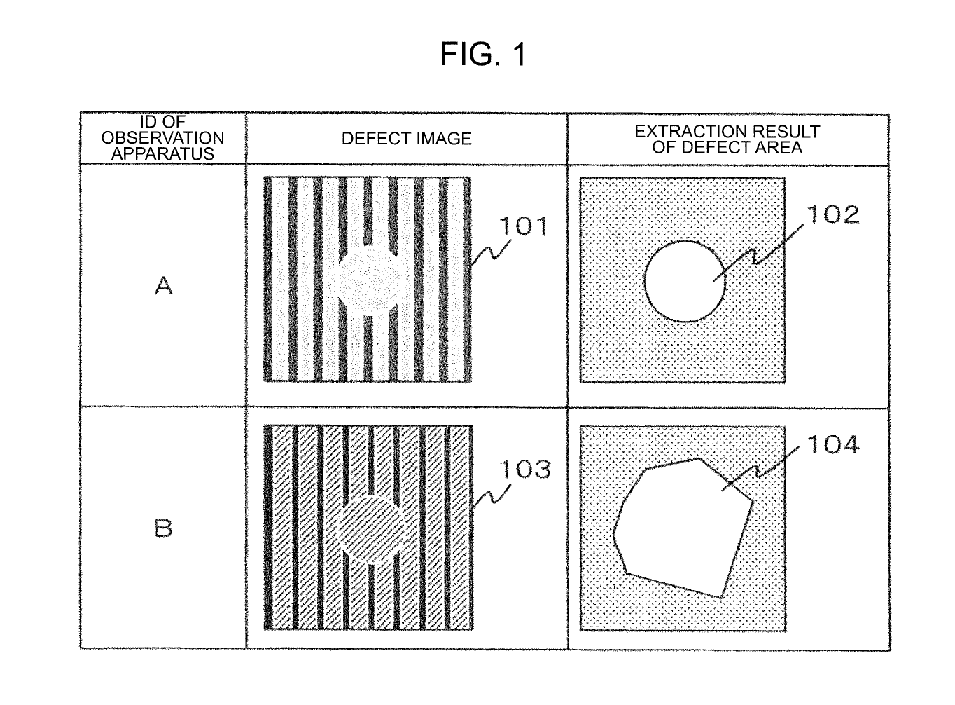

FIG. 2 shows in graphical representation the distribution in feature quantity space of defect images of the same defect, picked up by different observation apparatuses;

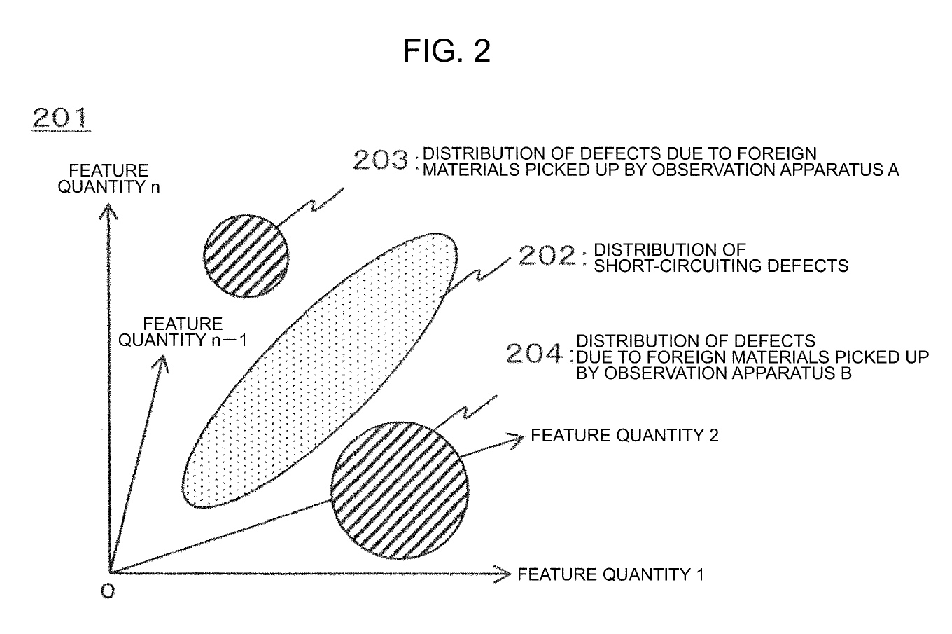

FIG. 3 schematically shows the structure of an image classification apparatus according to Embodiment 1 of this invention;

FIG. 4 schematically shows the structure of an observation apparatus;

FIG. 5 shows a network-connection in a semiconductor manufacturing line of an automatic image classification apparatus and a plurality of observation apparatuses, according to Embodiment 1 of this invention;

FIG. 6 illustrates the flow diagram of processing image classification;

FIG. 7 illustrates the flow diagram of processing the generation of a classification recipe according to Embodiment 1 of this invention;

FIG. 8 illustrates the flow diagram of processing the adjustment of image processing parameters according to Embodiment 1 of this invention;

FIG. 9 illustrates the flow diagram of processing the generation of a classification discriminating surface according to Embodiment 1 of this invention;

FIG. 10 illustrates an example of GUI exemplifying a defect area according to Embodiment 1 of this invention;

FIG. 11 illustrates another example of GUI exemplifying a defect area according to Embodiment 1 of this invention;

FIG. 12 illustrates an example of GUI which can identify and adjust image processing parameters according to Embodiment 1 of this invention;

FIG. 13 shows in graphical representation an example of generating a classification discriminating surface for classifying defect images picked up by observation apparatus A;

FIG. 14 shows in graphical representation an example of generating a classification discriminating surface for classifying defect images picked up by observation apparatus B;

FIG. 15 illustrates the flow diagram of processing the generation of a classification recipe according to Embodiment 2 of this invention;

FIG. 16 illustrates the flow diagram of processing the adjustment of image processing parameters according to Embodiment 2 of this invention;

FIG. 17 shows an example of a look-up table representing the correspondence relationship among the sets of parameters associated with respective observation apparatuses according to Embodiment 2 of this invention; and

FIG. 18 schematically shows the structure of an image classification apparatus according to Embodiment 2 of this invention.

### DESCRIPTION OF EMBODIMENTS

### Embodiment 1

A first embodiment of an image classification apparatus according to this invention will now be described below. This embodiment is described as applied to the case where images picked up by an observation apparatus equipped with a SEM (scanning electron microscope) are classified. However, images inputted to the image classification apparatus may be those other than SEM images, that is, for example, images picked up by an optical image pickup apparatus. Further, the input images may be a mixture of images picked up by optical image pickup apparatuses and images formed through the use of charged particle beams in, for example, a SEM.

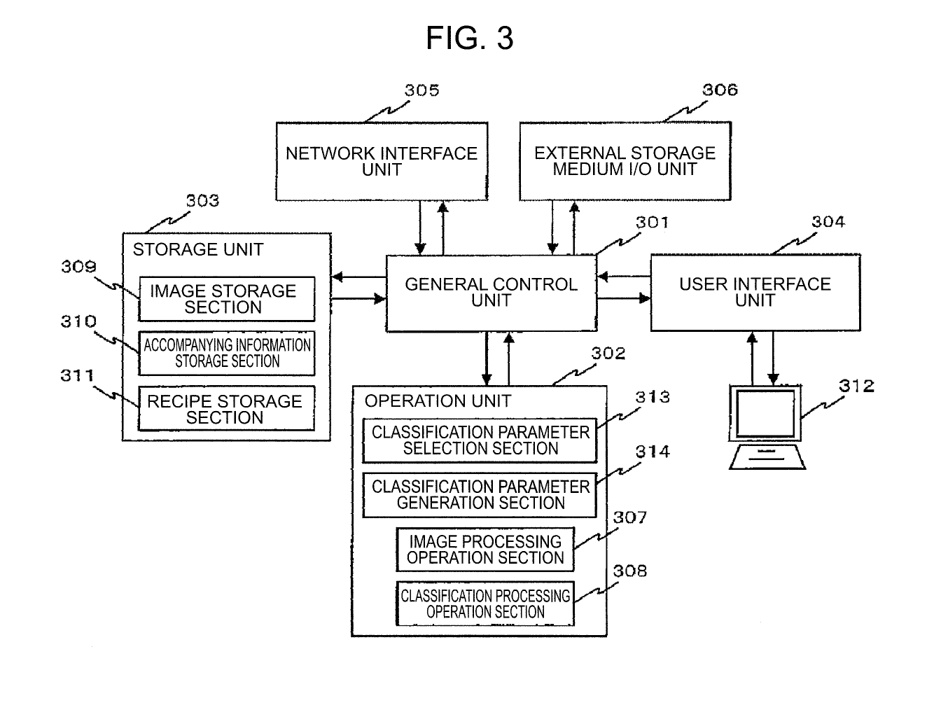

FIG. 3 schematically shows the structure of an image classification apparatus as a first embodiment of this invention. The image classification apparatus comprises, as appropriate, a general control unit 301 that controls the image classification apparatus as a whole; a operation unit 302 that operates in response to programs; a storage unit 303 in which magnetic disks or semiconductor memories store information; a user interface unit 304 that controls the information to and from users; a network interface unit 305 that performs communication with other observation apparatuses via a network; and an external storage medium I/O unit 306 that deliver signals to and receives signals from, external storage media. Of all these units, the operation unit 302 includes, as appropriate, an image processing operation section 307 that performs image processing; a classification processing operation section 308 that performs classification processing; a classification parameter generation section 314 that generates such classification parameters as described later; and a classification parameter selection section 313 that selects classification parameters. The storage unit 303 includes an image storage section 309 that stores images; an accompanying information storage section 310 that stores accompanying information of images; and a recipe storage section 311 that stores such conditions used for classification as image processing parameters and classification discriminating surfaces. The user interface unit 304 is connected with an I/O (input/output) terminal consisting of for example, a key board, a mouse and a display.

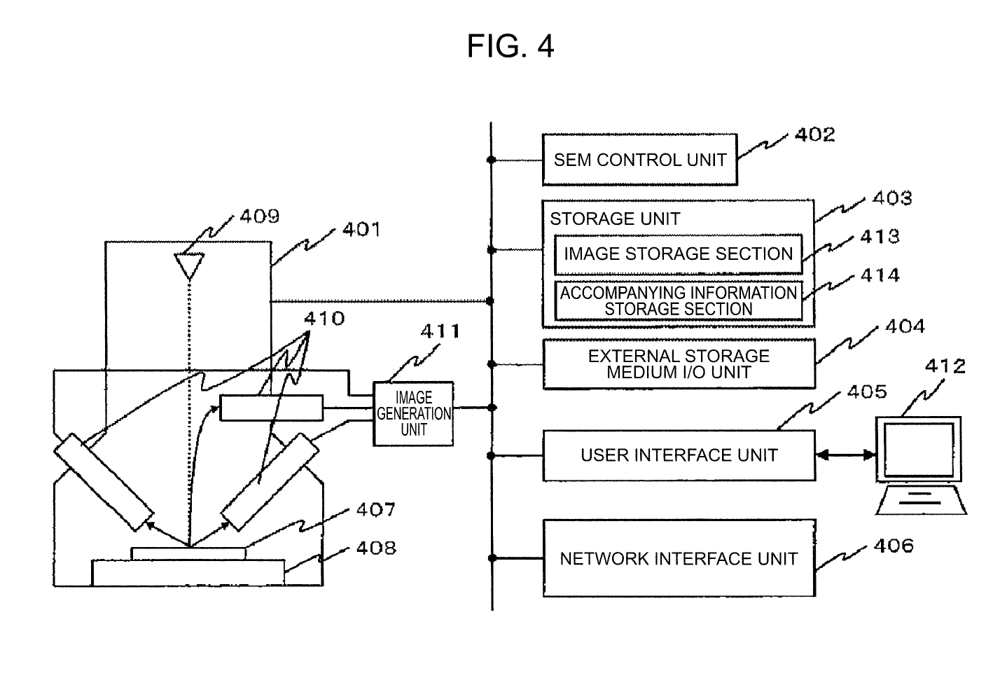

FIG. 4 schematically shows the structure of an example of an observation apparatus equipped with a SEM. The observation apparatus comprises, as appropriate, an electro-optical column 401; a SEM control unit 402; a storage unit 403; an external storage medium I/O unit 404; a user interface unit 405; and a network interface unit 406. The electro-optical column 401 includes, as appropriate, a movable stage 408 on which a sample wafer 407 is placed; an electron source 409 that casts an electron beam onto the sample wafer 407; detectors 410 that serve to detect secondary electrons or reflected electrons coming from the sample wafer 407 irradiated by the electron beam; a deflector (not shown) that scans the electron beam over the wafer sample 407; and an image generation unit 411 that converts analog signals outputted from the detectors 410 to corresponding digital signals to generate related digital images. The storage unit 403 includes an image storage section 413 that stores obtained image data; and an accompanying information storage section 414 that stores the accompanying information of the respective images when they were picked up (acceleration voltage, probe current, size of image field, management ID of observation apparatus used for image pickup, date and time of image pickup, coordinates of pickup images, etc.). The SEM control unit 402 serves to control such process as obtaining images. Instructions from the SEM control unit 402 may cause the movement of the movable stage 408 to bring a desired inspection area on the sample wafer 407 into the image field; the irradiation of the sample wafer 407 with the electron beam; the conversion of the data obtained by the detectors 410 to images; and the storage of the images in the storage unit 403. Various instructions from a user as an operator and the specification of conditions for image pickup are enabled by way of the I/O terminal 412 consisting of a key board, a mouse and a display, and connected with the user interface unit 405.

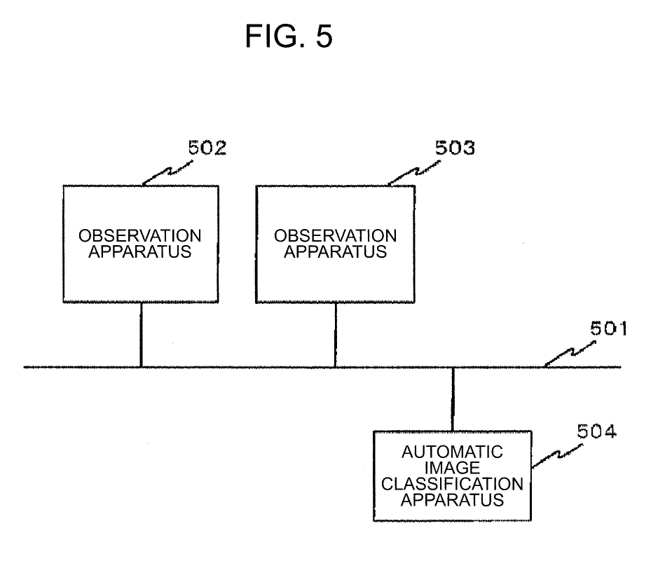

FIG. 5 schematically shows an automatic image classification apparatus and observation apparatuses according to this embodiment, connected with a network in a semiconductor manufacturing line. The automatic image classification apparatus 504 and the observation apparatuses 502, 503 are connected with a network 501. The observation apparatuses 502, 503 transmit via the network interface unit 406 the images stored in the image storage section 413 and the accompanying information stored in the accompanying information storage section 414. The automatic image classification apparatus 504 receives via the network interface unit 305 the images and accompanying information to store them respectively in the image storage section 309 and the accompanying information storage section 310. The data on the images and accompanying information may be copied or moved for a transmission or reception of the data by the external storage medium I/O unit 404 of the observation apparatus and the external storage medium I/O unit 306 of the automatic image classification apparatus via external storage media such as magnetic disks, optical disks and semiconductor memories. In FIG. 5, two observation apparatuses are shown, but it is noted that more than two observation apparatuses may be employed. In general, observation apparatuses are placed in a clean room, but an automatic image classification apparatus may be placed either within or without a clean room.

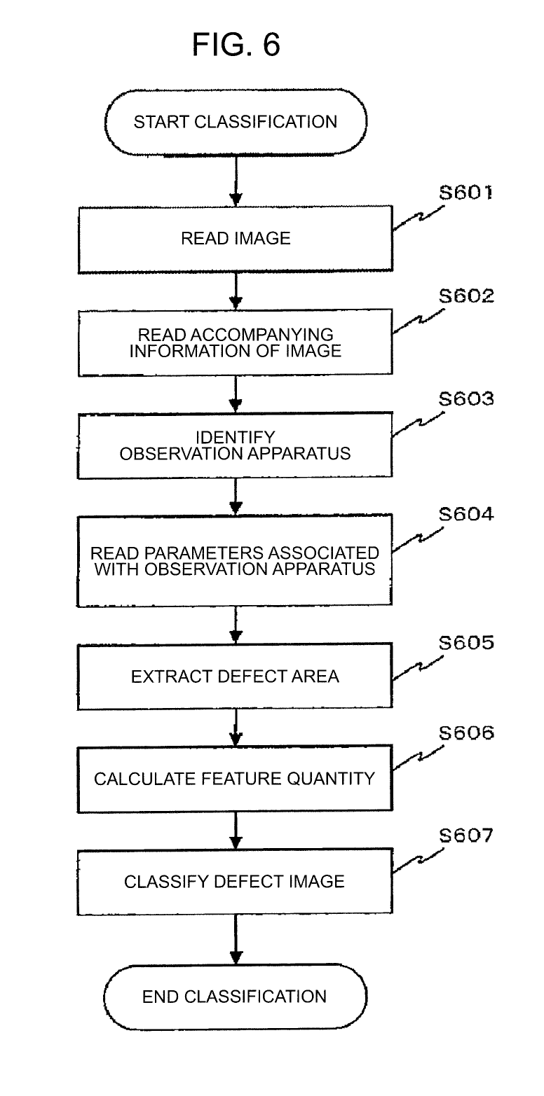

FIG. 6 illustrates a flow chart for the process in which the automatic image classification apparatus according to this embodiment performs to classify inputted images.

To begin with, a defect image to be classified is read from the image storage section 309 (S601). Then, the accompanying information of the defect image is read from the accompanying information storage section 310 (S602). Incidentally, the defect image and its accompanying information may be read simultaneously. It is noted here that the accompanying information of the defect image is condition for the defect image defined when it was picked up and may include, as appropriate, the ID of the observation apparatus which picked up that defect image. Further, the acceleration voltage and probe current at the time of picking up that defect image, the size of image field, the data and time when the defect image was picked up, and the coordinates of the obtained defect image may be stored as additional accompanying information and they can be used later as information for classification. Next, depending on the accompanying information of the read defect image, the observation apparatus that picked up the very defect image is identified by the classification parameter selection section 313 (S603). To do this, the ID of the observation apparatus included in the accompanying information of the defect image may be used. Alternatively, this identification can also be done by providing the image storage section 309 with hierarchical structures (directories), grouping the defect images transmitted from observation apparatuses, with respect to the observation apparatuses, and storing the thus grouped defect images separately in different directories. Next, the classification parameter selection section 313 reads the set of classification parameters associated with the observation apparatus that picked up the defect image to be classified (S604). The set of classification parameters are among those which are generated in correspondence with respective observation apparatuses in a way described later. It is noted here that the classification parameters may refer not only to such parameters used as classification discriminating surfaces in classification but also to such image processing parameters as used for the extraction of defect areas from defect images and for the operation of feature quantities. Now, the image processing operation section 307 extracts the defect area of a defect image by using the corresponding image processing parameters included in the related classification parameters read in (S605). The image processing operation section 307 also operates the quantified value that is obtained by quantifying the feature of the defect extracted from the defect area of the defect image (S606). Finally, the classification processing operation section 308 classifies the defect image by using the calculated feature quantity and the classification discriminating surface contained in the set of classification parameters (S607). As a procedure for classifying defects, a neural network or an SVM (support vector machine) may be used, or the procedure disclosed in the above mentioned patent literature 2 may also be used which is a combination of a rule-based classifier and an example-based classifier. It is noted here that the process flow described above is concerned with a case where only one defect image is subjected to classification. To classify a plurality of defect images, it is only necessary to iterate the steps S601 through S607 number of times equal to the number of the defect images to be classified. Alternatively, parallel processing may be employed wherein a plurality of image processing operation sections and a plurality of classification processing operation sections are provided.

Further, images to be picked up may include not only at least a defect image representative of defect portion to be classified but also a perfect image representative of non-defect area corresponding to the defect image, the perfect image being formed by picking up an image of the same circuit pattern having no defect in it. The information on the perfect image can be used in the processing such as the extraction of defect areas and in the operation of feature quantities, through the comparison between the defect image and the perfect image. Moreover, a plurality of images may be picked up by different detectors at a single coordinate point of image pickup. For example, in case of a SEM being used, available are secondary electron images formed mainly by detecting secondary electrons and back-scattered electron images formed by detecting back-scattered electrons, or other types of defect images formed by selectively combining these two kinds of images in a known way.

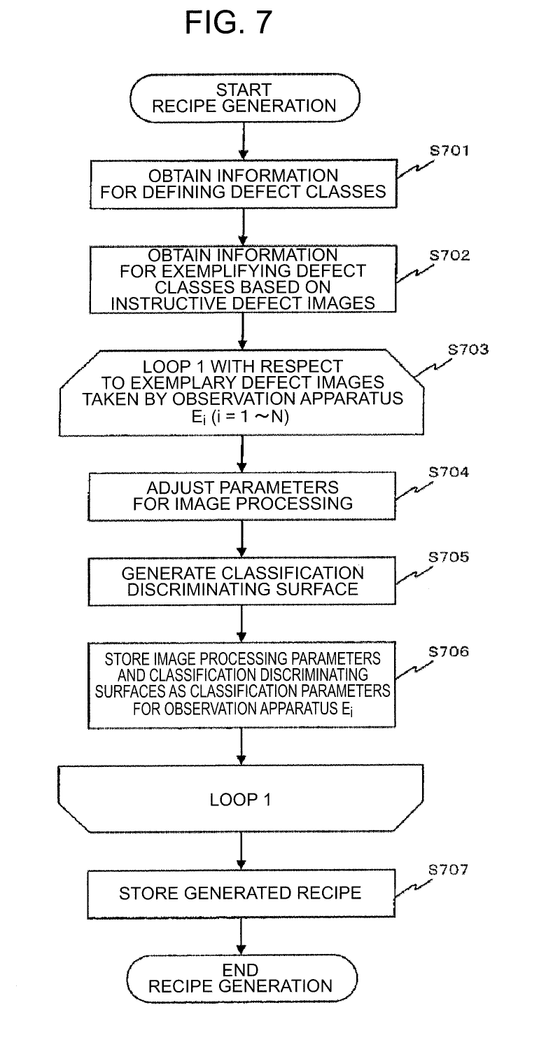

FIG. 7 illustrates in flow diagram a procedure for making a classification recipe by a classification parameter generation section 314. The classification recipe refers to information that defines the method of classifying defect images. And the recipe includes types or classes (categories) of defects to be classified, image processing parameters, and classification discriminating surfaces used for classifying defects into appropriate classes. In general, semiconductor wafer manufacture process comprises a plurality of manufacturing steps. Accordingly, since different steps may generate different types of defects, it is usually necessary to prepare classification recipes adapted to respective steps. In making a classification recipe, the I/O terminal 312 obtains the information such as the definition to classify detected images into the classes that a user provided as input via the terminal 312 (S701). Further, on the basis of the several defect images shown on the display screen for exemplifying purpose, the I/O terminal obtains the information that exemplifies the defect classes which the user provided as input (S702). This may be performed in such a manner that as disclosed in the Patent Literature 4 given above, classes are exemplified by moving defect images represented as icons on the display to windows allocated to respective classes. After exemplifying classes, process steps S704 through S706 are repeated with respect to exemplifying images picked up by observation apparatuses Eᵢ (i=1˜N: N is the number of observation apparatuses involved) (S703). S704 is the step of adjusting parameters for image processing in the method described later. S705 is the step of generating classification discriminating surface. S706 is the step of storing the results obtained in the respective steps as classification parameters used for the observation apparatuses E. In this way, N sets of classification parameters are stored in a single classification recipe. Finally, the thus generated classification recipes are stored in the recipe storage section 311 (S707).

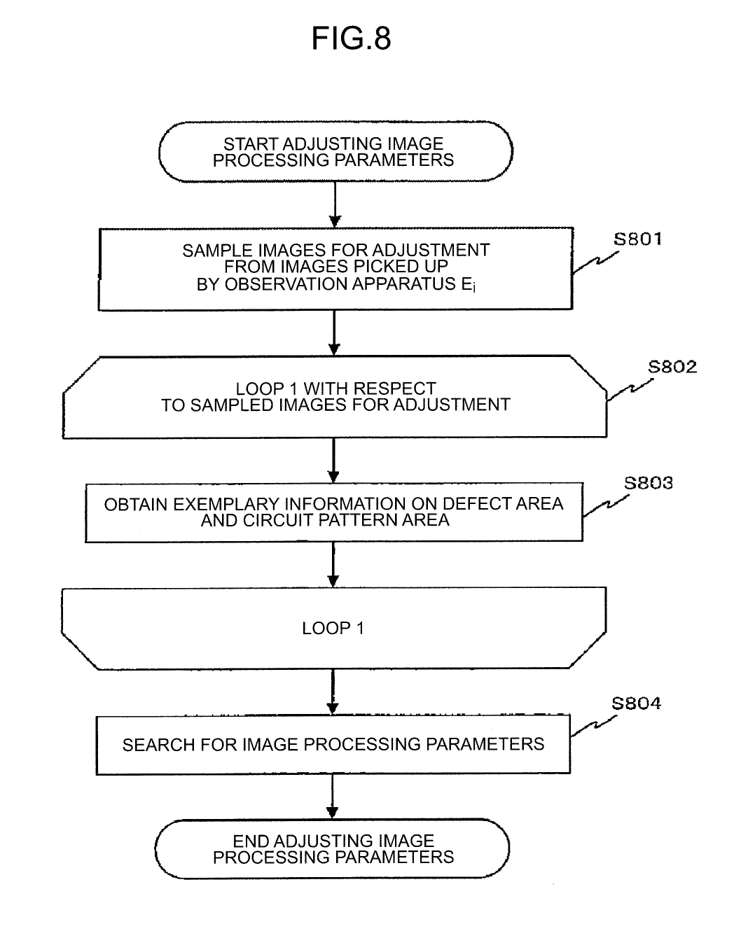

FIG. 8 illustrates in flow diagram the detail of the process step (S 704) of adjusting the parameters for image processing in the generation of classification recipe. According to this process step, defect areas and circuit pattern areas are exemplified with respect to a small number of defect images sampled from exemplifying images, whereby image processing parameters can be calculated which appropriately enable defect areas to be extracted and feature quantities to be calculated, with respect to a great number of defect images. The parameters relating to the extraction of defect areas include, for example, binary thresholds, mixture ratios of multi-channel images, and identifiers for algorithms to be used. The parameters related to the calculation of feature quantities include the difference in tone (or grey scale) between base surface and circuit pattern thereon (regarding which is brighter) and identifiers for algorithms to be used. In adjustment, a plurality of images for adjustment are sampled from images picked up by observation apparatus Eᵢ (S801). To be concrete, about several (e.g. three) defect images have only to be sampled randomly from defect images included in respective classes depending on the result exemplified in the step S702. Next, with respect to all the sampled images for adjustment, the I/O terminal 312 obtains exemplified information on defect areas and circuit patterns exemplified by a user (S802, S803). Then, appropriate image processing parameters are searched for on the basis of the obtained exemplified defect areas and circuit pattern areas (S804). The simplest procedure to obtain appropriate parameters is to perform image processing using combinations among all the parameters and to obtain a set of image processing parameters that can generate a result nearest to the exemplified result. Or alternatively, an appropriate set of parameters may be obtained without searching for all the parameters but from assessment values regarding some of the entire set of parameters, by using the orthogonal table as in the Taguchi Method.

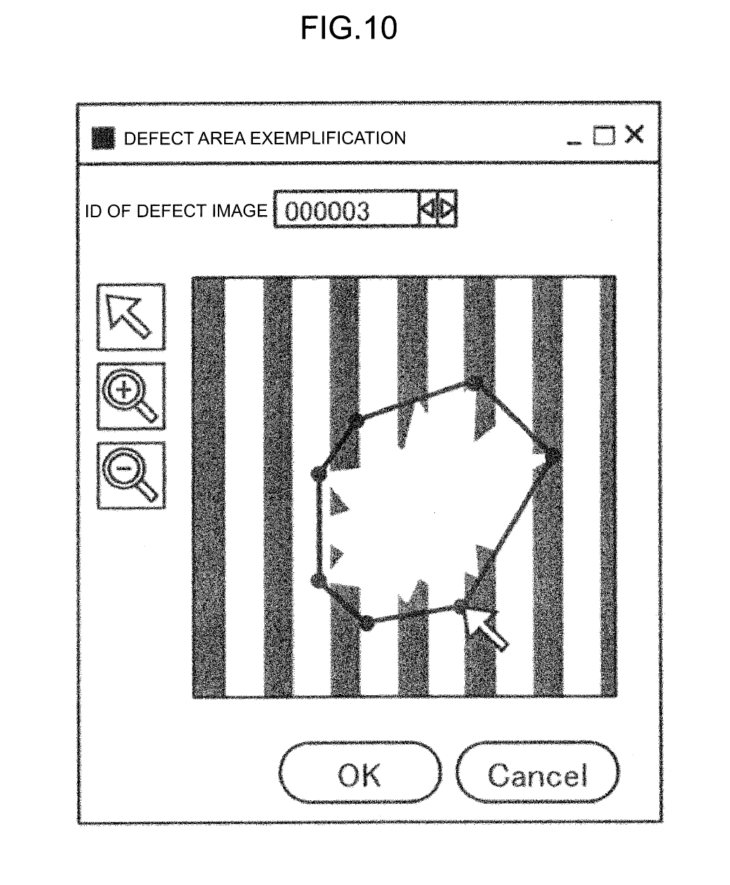

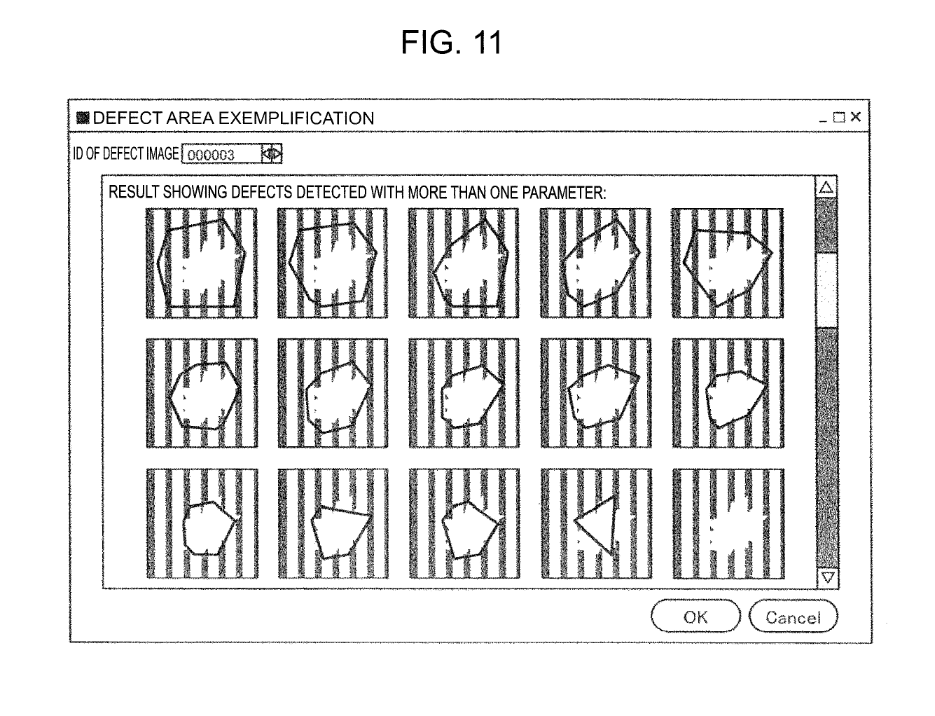

Now, a concrete procedure is given of how exemplifying information on defect areas obtained by the I/O terminal 312 is exemplified. One of such exemplifying procedures is to display a sampled defect image on the display screen as shown in FIG. 10 and then to allow a user to specify the defect area by using a mouse or a pen-and-tablet. Another procedure is to previously extract defect areas, as shown in FIG. 11, by using a plurality of image processing parameter sets and then to display the extracted results on the screen, and finally to select that defect area which corresponds to the best extracted result. Although this procedure is described as used for exemplification related to the extraction of defect areas, it can also be applied to the exemplification of circuit pattern areas.

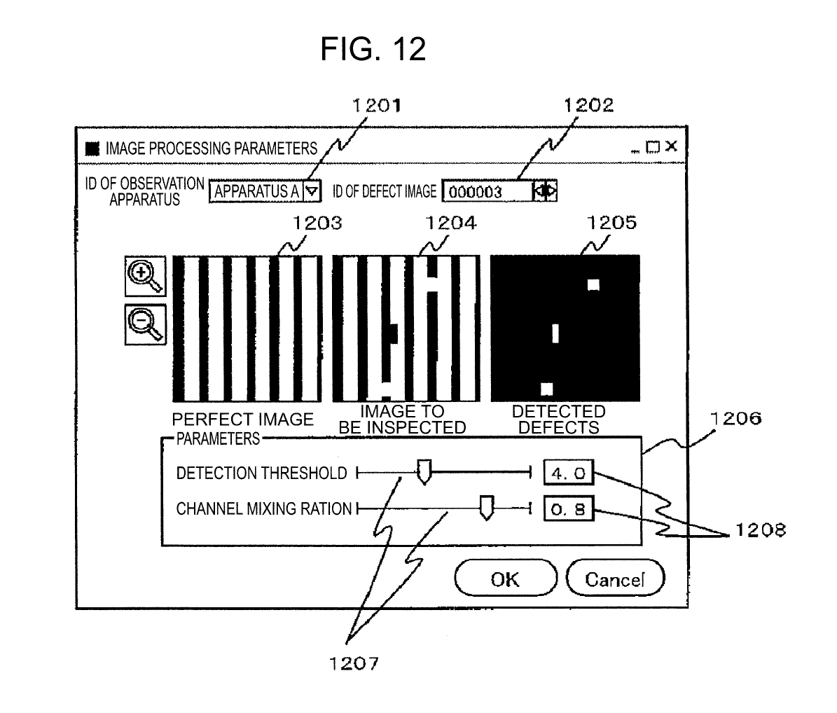

The image classification apparatus according to this embodiment ascertains the image processing parameters adjusted in S704 and, if necessary, is provided with a GUI (graphic user interface) which enables the modification of parameters. An example of GUI that can ascertain and modify the image processing parameters is shown in FIG. 12. In FIG. 12 are shown a list 1201 of observation apparatuses to be selected; a list 1202 for selecting a defect image; a window 1203 for displaying a perfect image corresponding a selected defect image; a window 1204 for displaying a selected defect image; a window 1205 for displaying the extracted defect image obtained with the preset parameters; and an interface 1206 for adjusting the values of parameters. A user can adjust parameters via the interface as need arises while observing the window 1205 that displays the result of defect area extraction. The interface 1206 for adjusting the values of parameters includes, as appropriate, sliders 1207 that can change the values of parameters as their graduations change and text boxes 1208 in which values are inputted.

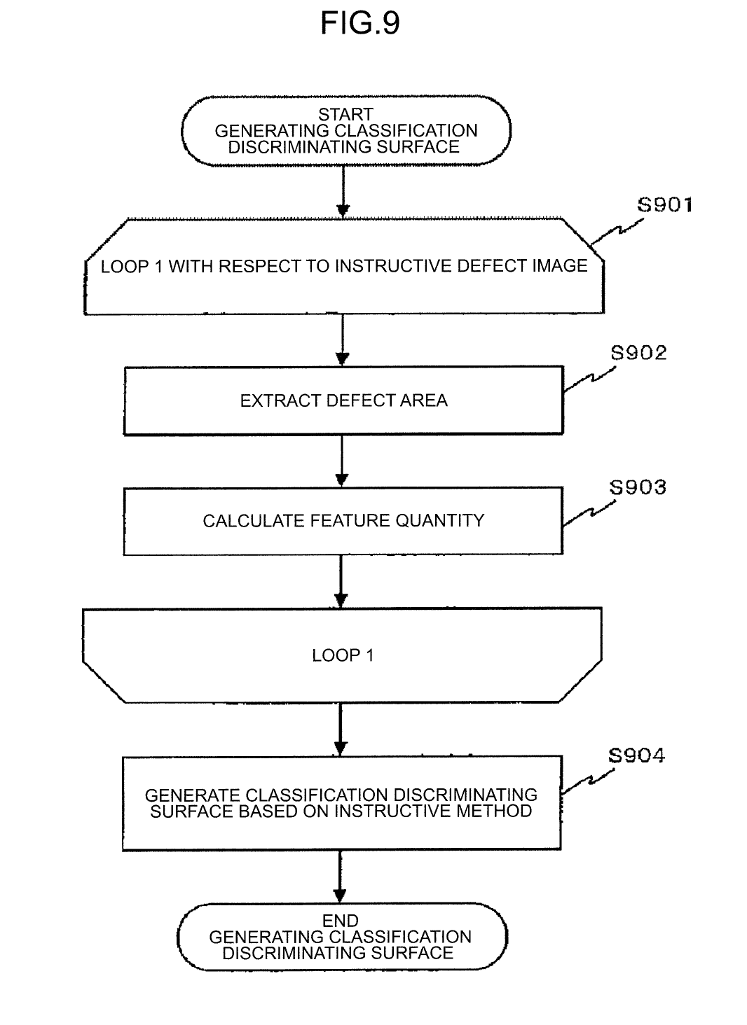

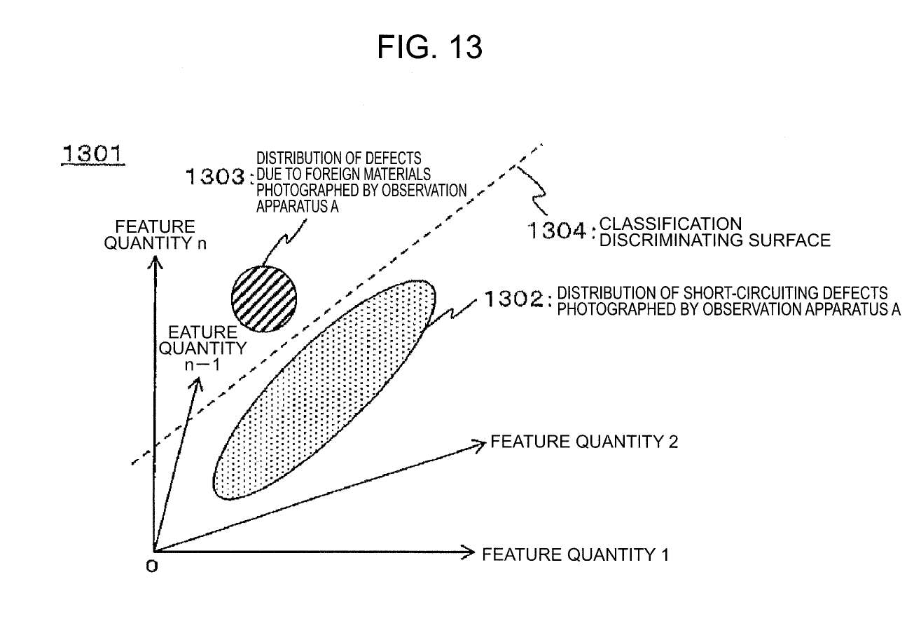

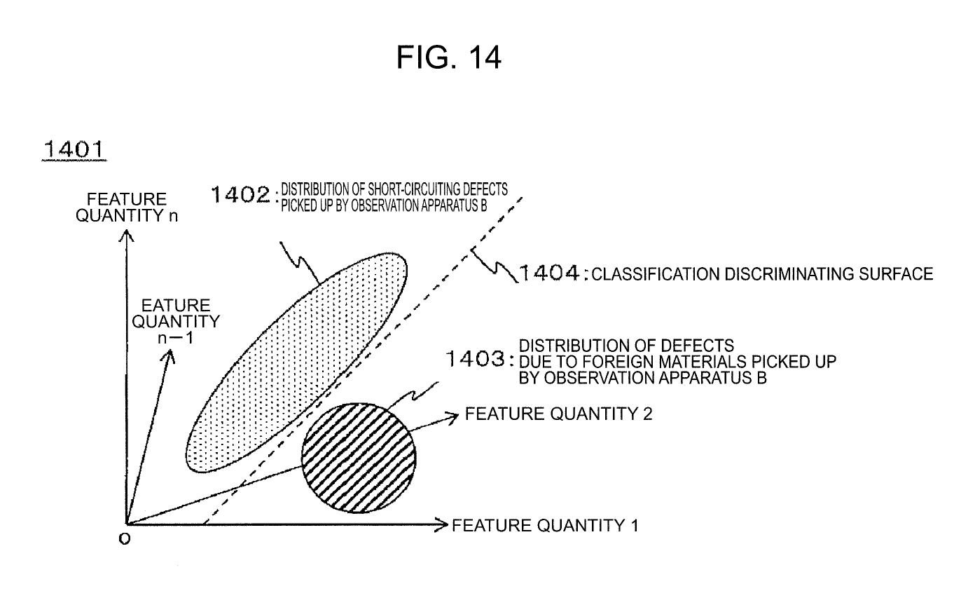

FIG. 9 illustrates in flow diagram the generation of classification discriminating surface (S705) in classification recipe generation. With respect to all the exemplifying images, the extraction (S902) of defect areas and the calculation (S903) of feature quantities are repeatedly performed (S901) by using parameters obtained through the adjustment (S704) of image processing parameters. Then, classification discriminating surface is generated (S904) by studying an example-based classifier such as a neural network or a SVM for use in classification on the basis of the calculated feature quantity and the defect class exemplified in S702. FIG. 13 graphically shows an example of a classification discriminating surface generated for the purpose of classifying defect images picked up by the observation apparatus A. Since the generation of a classification discriminating surface takes place independently for each observation apparatus (S703˜S705), no distribution of images picked up by the observation apparatus B appears in the n-dimensional feature quantity space 1301. Accordingly, the discrimination surface 1304 that can separate the distribution 1303 of defects due to foreign substances and the distribution 1302 of short-circuiting defects from each other, can be easily obtained. Similarly, FIG. 14 graphically shows an example of a classification discriminating surface generated to classify defect images picked up by the observation apparatus B. In FIG. 14 are depicted the n-dimensional feature space 1401, the distribution 1402 of short-circuiting defects, and the distribution 1403 of defects due to foreign substances. In this case, too, since the distribution of images picked up by any observation apparatus other than the observation apparatus B, is not involved, then the classification discriminating surface 1404 can be easily calculated.

As described above, according to this embodiment, the image classification apparatus receives as inputs in a mixed way defect images picked up by a plurality of observation apparatuses; sets of classification parameters are generated which correspond to the observation apparatuses that picked up those defect images; and defect classification is performed by using the thus generated parameter sets. Accordingly, the degradation of classification accuracy due to scattering image qualities can be suppressed, and therefore the classification of defect mages can be performed with high classification accuracy. Further, by exemplifying defect areas for defect images picked up by respective observation apparatuses, sets of image processing parameters can be automatically adjusted and the sets of classification parameters can be easily generated for the respective observation apparatuses.

Although this embodiment is described as applied to a case where defect images picked up by a plurality of observation apparatuses are used in a mixed way, other types of defect images can also be used. Actually, this embodiment can be applied to not only defect images picked up by an optical image pickup apparatus but also defect images picked up by various types of image pickup apparatuses connected via a network with the image classification apparatus of this embodiment.

### Embodiment 2

A second embodiment of an image classification apparatus according to this invention will be described below. In the following description of the second embodiment, those portions of structure and flow diagram which are the same as those given in the first embodiment described above will be omitted, and those portions of structure and flow diagram which are different from those given in the first embodiment will be mainly described. To be concrete, this embodiment relates to a method according to which an image classification apparatus, which performs defect classification by following the processing flow similar to that used in the first embodiment, generates image processing parameters for respective observation apparatuses by exemplifying a fewer defects and circuit patterns than in the first embodiment in the procedure of recipe generation. This embodiment is described as applied to the case where images picked up by an observation apparatus equipped with a SEM are classified similar to the first embodiment. However, image input to the image classification apparatus according to this embodiment may be those other than SEM images, that is, for example, images picked up by an optical image pickup apparatus. Further, the input images may be a mixture of images picked up by optical image pickup apparatuses and images formed through the use of charged particle beams in, for example, a SEM.

The classification processing flow used with the image classification apparatus according to this second embodiment is similar to the classification processing flow (see FIG. 6) used in the first embodiment described above. Further, the connection of the image classification apparatus with the observation apparatuses via the network in the semiconductor manufacturing line according to this second embodiment is also similar to the corresponding connection (see FIG. 5) used in the first embodiment described above. Furthermore, the image classification apparatus according to this second embodiment includes a GUI similar to that used in the first embodiment described above. Hereafter, the processing of generating a classification recipe, especially the procedure of adjusting image processing parameters, particularly that portion of the procedure that was not covered in the first embodiment, will be described.

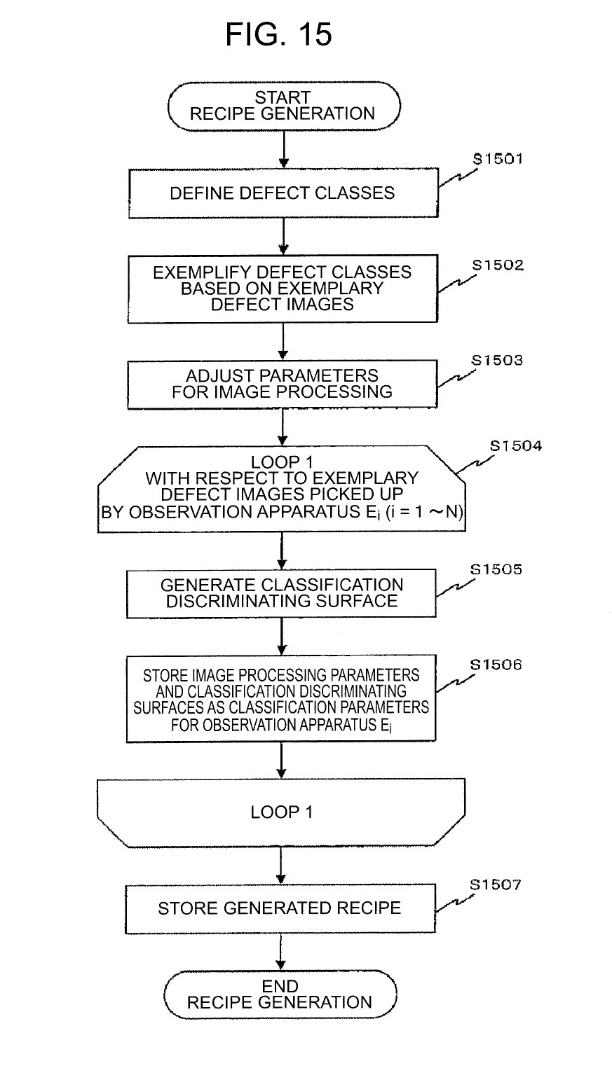

FIG. 15 illustrates in flow diagram the process of generating a recipe in the image classification apparatus according to this embodiment. In FIG. 15, the processing performed in steps S1501, S1502, S1504˜S1507 are the same as the processing in the corresponding steps in the first embodiment, but the order of the processing steps being performed and the content of processing in the process flow within the image processing parameter adjustment S1503 are different from those in the first embodiment.

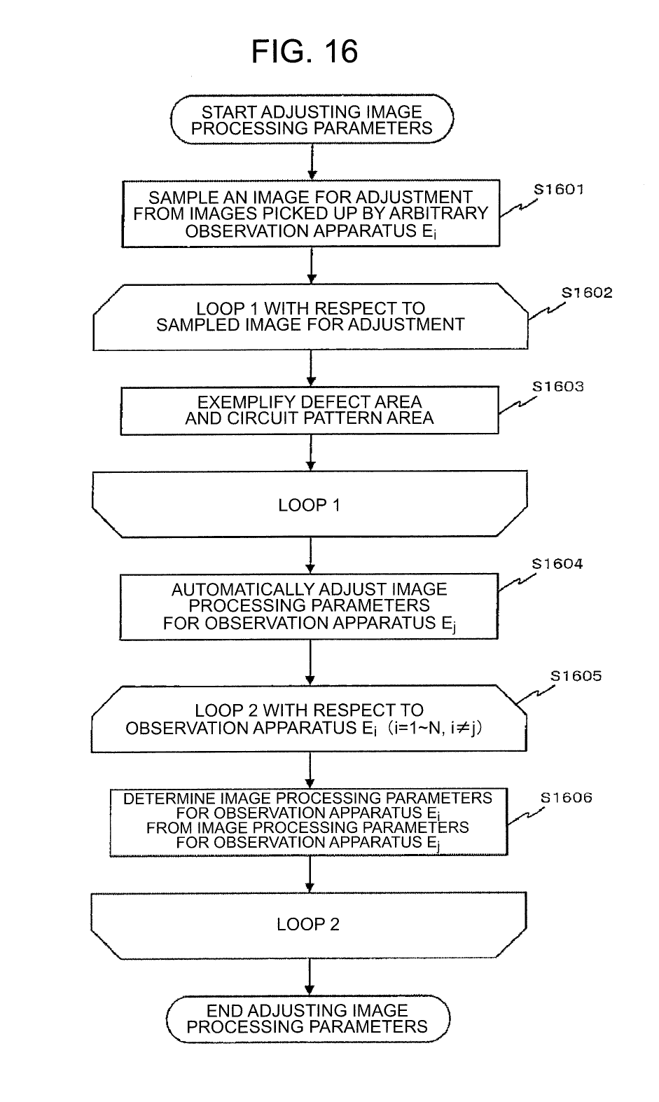

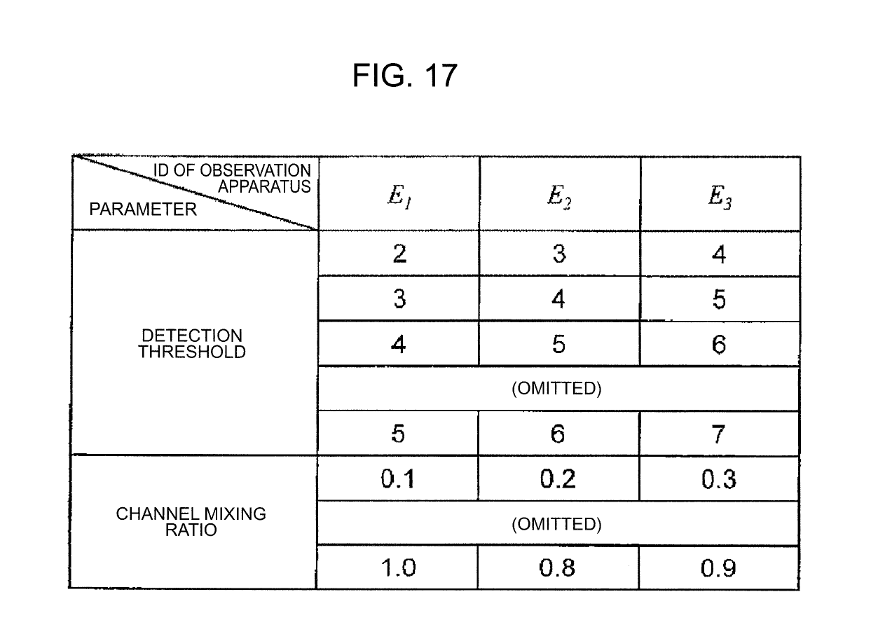

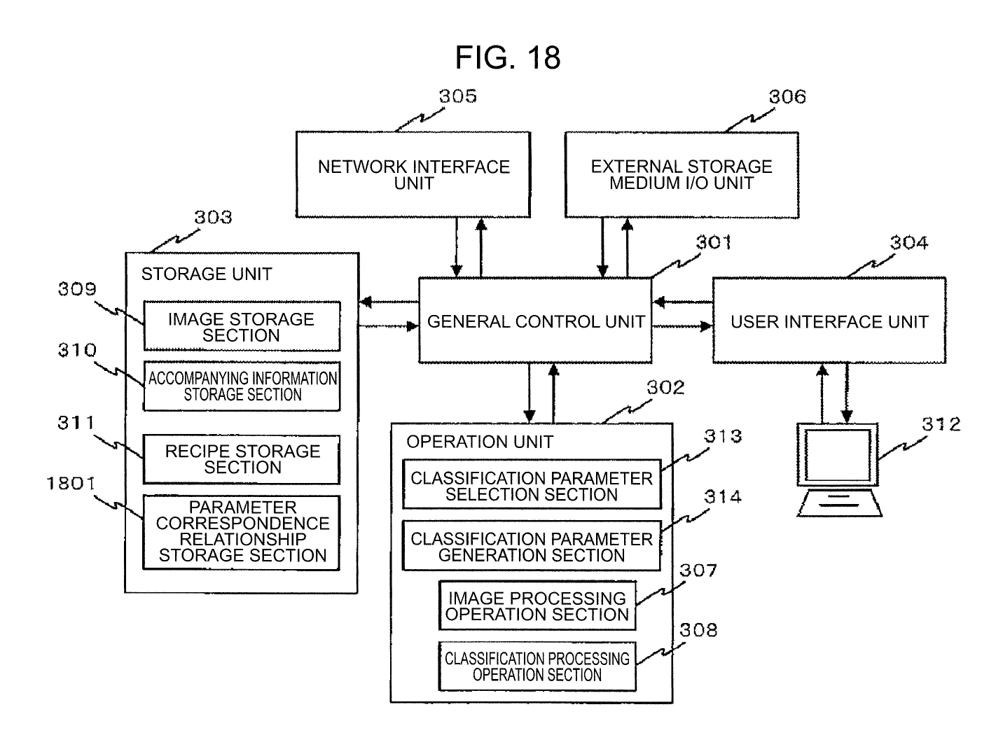

FIG. 16 shows in flow diagram the detail of the image processing parameter adjustment S1503. First, an image to be used for adjustment is sampled from images picked up by an arbitrary observation apparatus Eⱼ through a procedure similar to the step S801 described in the first embodiment. Then, with respect to the image sampled for adjustment, its defect area and circuit pattern area are exemplified through a procedure similar to the step S803 described in the first embodiment. After the defect area and circuit pattern area have been exemplified, an appropriate set of image processing parameters is searched for through a procedure similar to the step S804 described in the first embodiment. Next, in the image classification apparatus according to the second embodiment, the sets of image processing parameters for observation apparatuses Eᵢ (i=1˜N, where i≠j) for which exemplification did not take place, are determined on the basis of the set of image processing parameters adjusted for the observation apparatus Eᵢ (S1605, S1606). As for the change of parameters from one observation apparatus to another, a look-up table as shown in FIG. 17, which was previously compiled to comparatively show the sets of parameters of respective observation apparatuses, may be utilized. To compile this look-up table, it is necessary to pick up the images of a defect by all the observation apparatuses, to process the image picked up by an arbitrary observation apparatus with a plurality of parameter sets, and to search a parameter set which leads to the same result as produced by another observation apparatus. For example, image processing is performed on the image picked up by the observation apparatus E1 by using four types of detection thresholds 2˜5; image processing is performed on the same image picked up by the observation apparatus E2 by using four types of detection thresholds 3˜6; and the set of parameters for E 1 and the set of parameters for E2, which give the same processing result, are considered exchangeable. Alternatively, the correspondence among qualitative characteristics of optical systems of observation apparatuses once stored in the storage may then be used for comparison to establish such a look-up table. The look-up table previously established for showing the corresponding relationship among respective observation apparatuses may preferably be stored in a parameter correspondence relationship storage section 1801 in the storage unit 303 as shown in FIG. 18.

In this embodiment, sets of image processing parameters can be easily and beforehand determined without repeating the loop consisting of S1504˜S1506 as shown in FIG. 5, if use is made of the conversion using the look-up table that shows the corresponding relationship among respective observation apparatuses, in the determination of image processing parameters.

Although this embodiment is described as applied to a case where defect images picked up by a plurality of observation apparatuses are used in a mixed way, other types of defect images can also be used. Actually, this embodiment can be applied to not only defect images picked up by an optical image pickup apparatus but also defect images picked up by various types of image pickup apparatuses connected via a network with the image classification apparatus of this embodiment.

In the foregoing, this invention has been concretely described by way of embodiments. However, this invention is no way limited to those embodiments alone, but can occur in various modifications and alterations without departing the scope of the invention.

### REFERENCE SIGNS LIST

304 User interface unit, 305 Network interface unit, 307 Image processing operation section, 308 Classification processing operation section, 309 Image storage section, 310 Accompanying information storage section, 311 Recipe storage section, 312 I/O terminal, 313 Classification parameter selection section, 314 Classification parameter generation section, 401 Scanning electron microscope, 405 User interface unit, 406 Network interface unit, S602 Reading accompanying information of image, S603 Identifying observation apparatus, S604 Reading classification parameters corresponding to observation apparatus, S605 Extracting defect area, S606 Calculating feature quantity, S607 Classifying defects, S704 Adjusting image processing parameters, S705 Generating classification discriminating surface, S803 Exemplifying defect area and circuit pattern area, S804 Searching for image processing parameters, S904 Generating classification discriminating surface based on learning, S1606 Converting image processing parameters, 1801 Storing corresponding relationship among parameters.

1. An image classification method for classifying a plurality of defect images picked up by a plurality of different image pickup apparatuses according to types of defects, comprising the steps of:
reading accompanying information of a defect image to be classified;
identifying, from the plurality of the different image pickup apparatuses, the image pickup apparatus which picked up the defect image to be classified, on the basis of the read accompanying information of the defect image to be classified;
reading a set of classification parameters for the identified image pickup apparatus from a plurality of classification parameter sets previously compiled for the plurality of the different image pickup apparatuses; and
classifying the defect image to be classified by using the read set of classification parameters.

2. An image classification method according to claim 1, wherein the step of classifying the defect image to be classified comprises the steps of:
extracting the defect area from the defect image to be classified, by using image processing parameters included in the read set of classification parameters; and
calculating the feature quantity of the extracted defect area by using the image processing parameters.

3. An image classification method according to claim 2, wherein the step of classifying the defect image to be classified further comprises a step of classifying the defect image to be classified, by using a classification discriminating surface included in the read set of classification parameters and the calculated feature quantity.

4. An image classification method according to claim 2, further comprising a step of generating the set of classification parameters before the step of reading the set of classification parameters, wherein the step of generating the set of classification parameters includes the steps of:
exemplifying defect areas with respect to a plurality of defect images obtained by the plurality of different image pickup apparatuses; and
determining the image processing parameters on the basis of the exemplified defect areas.

5. An image classification method according to claim 2, further comprising a step of generating the set of classification parameters before the step of reading the set of classification parameters, wherein the step of generating the set of classification parameters includes the steps of:
exemplifying circuit pattern areas with respect to a plurality of defect images obtained by the plurality of different image pickup apparatuses; and
determining the image processing parameters on the basis of the exemplified circuit pattern areas.

6. An image classification method according to claim 2, further comprising a step of generating the set of classification parameters before the step of reading the set of classification parameters, wherein the step of generating the set of classification parameters includes the steps of:
exemplifying defect areas with respect to a plurality of defect images obtained by the plurality of different image pickup apparatuses;
exemplifying circuit pattern areas with respect to a plurality of defect images obtained by the plurality of different image pickup apparatuses; and
determining the image processing parameters on the basis of the exemplified defect areas and circuit pattern areas.

7. An image classification method according to claim 2, further comprising a step of generating the set of classification parameters before the step of reading the set of classification parameters, wherein the step of generating the set of classification parameters includes a step of:
determining, by using a set of image processing parameters determined on the basis of a defect image obtained by at least one image pickup apparatus selected from the plurality of the different image pickup apparatuses, a set of image processing parameters for another image pickup apparatus.

8. An image classification method according to claim 7, wherein in the step of determining the set of image processing parameters for another image pickup apparatus, the image processing parameters are determined by converting the set of image processing parameters determined on the basis of the defect image obtained by the at least one image pickup apparatus, through the use of a look-up table showing the correspondence relationship among the sets of parameters for the plurality of the different image pickup apparatuses.

9. An image classification method according to claim 4, wherein the step of generating the sets of classification parameters includes a step of generating the classification discriminating surfaces for classifying defect imagers for the plurality of the different image pickup apparatuses.

10. An image classification apparatus that classifies a plurality of defect images picked up by a plurality of different image pickup apparatuses according to types of defects, comprising
a storage unit that stores the defect images, pieces of accompanying information corresponding respectively to the defect images, and sets of classification parameters which correspond respectively to the plurality of different image pickup apparatuses;
a classification parameter selection unit that selects and identifies the image pickup apparatus which picked up the defect image to be classified, from among the plurality of different image pickup apparatuses on the basis of the piece of accompanying information corresponding to the defect image to be classified, read from the storage unit and that selectively writes therein the set of classification parameters corresponding to the identified image pickup apparatus;
a classification processing unit that classifies the defect image to be classified, on the basis of the set of parameters selected by and written in, the classification parameter selection unit; and
a display unit that displays the classification results obtained by the classification processing unit.

11. An image classification apparatus according to claim 10, further comprising an image processing unit that extracts the defect area from the defect image to be classified, by using image processing parameters included in the set of classification parameters selectively written in the classification parameter selection unit, and that calculates the feature quantity of the extracted defect area,
wherein the classification processing unit classifies the defect image to be classified, by using a classification discriminating surface included in the set of classification parameters and the calculated feature quantity.

12. An image classification apparatus according claim 10, further comprising a classification parameter generating unit that generates the sets of classification parameters stored in the storage unit,
wherein the classification parameter generating unit adjusts the image processing parameters included the classification parameters on the basis of exemplary information on defect areas corresponding to the defect images.

13. An image classification apparatus according claim 10, further comprising a classification parameter generating unit that generates the sets of classification parameters stored in the storage unit,
wherein the classification parameter generating unit adjusts the image processing parameters included the classification parameters on the basis of exemplary information on circuit patterns corresponding to the defect images.

14. An image classification apparatus according claim 10, further comprising a classification parameter generating unit that generates the sets of classification parameters stored in the storage unit,
wherein the classification parameter generating unit determines, by using a set of image processing parameters determined on the basis of a defect image obtained by at least one image pickup apparatus selected from the plurality of the different image pickup apparatuses, a set of image processing parameters for another image pickup apparatus.

15. An image classification apparatus according to claim 14, wherein by converting the set of image processing parameters determined on the basis of the defect image obtained by the at least one image pickup apparatus, through the use of a look-up table showing the correspondence relationship among the sets of parameters for the plurality of the different image pickup apparatuses, the classification parameter generating unit determines a set of image processing parameters for another image pickup apparatus.
